(19) United States
(12) Patent Application Publication
(10) Pub. No.: US 2007/0298185 A1
(43) Pub. Date: Dec. 27, 2007

(54) Seamless mannequin and process of manufacture thereof

(75) Inventor: Simon Siu Man Nan, Ontario (CA)

Correspondence Address: GREENSFELDER HEMKER & GALE PC, SUITE 2000, 10 SOUTH BROADWAY, ST LOUIS, MO, 63102, US

(73) Assignee: Nanma Manufacturing Co. Ltd.

(21) Appl. No.: 11/899,222

(22) Filed: Sep. 5, 2007

Related U.S. Application Data
(63) Continuation-in-part of application No. 10/984,294, filed on Nov. 9, 2004.

(51) Int. Cl. B05D 1/18; B29D 22/00

(52) U.S. Cl. 427/430.1; 264/632; 428/15

(57) ABSTRACT

A seamless life-like mannequin comprising a unitary inflatable outer body with an inflatable inner body disposed therein and a related process of manufacturing such a mannequin is disclosed. The outer body of the mannequin comprises a torso portion and a head portion with a seamless transition between the two portions for providing a realistic life-like appearance to the mannequin.

### CROSS-REFERENCE TO RELATED APPLICATIONS

This application is a continuation-in-part of copending U.S. patent application Ser. No. 10/984,294 (referred to herein as the '294 application), filed on Nov. 9, 2004, which names Simon Siu Man Nan as inventor and is entitled “Seamless Mannequin And Process Of Manufacture Thereof.” This application claims priority benefit to the '294 application. The disclosure of the '294 application is hereby incorporated by reference in its entirety.

### BACKGROUND OF THE INVENTION

The present invention relates to a life-like mannequin and process of manufacturing the same.

There are many inflatable products available on the market today. Generally, these products assume a substantially flat, two-dimensional shape when deflated, and a three-dimensional shape when inflated. The inflated product is often one that provides buoyancy in the water, and has a nondescript geometric shape. However, novelty inflatable products that assume a recognizable shape when inflated are also available. Some of these novelty products are animal-shaped, and are sold as toys for children. Others are shaped like mannequins, either for use in displaying items of clothing, or for sale as an adult novelty.

Typically, an inflatable mannequin may comprise an outer body including a torso portion mechanically connected to a head portion in order to provide life-like features to the mannequin. In order to produce such life-like features the head portion may be produced using a slush and rotational molding process whereby a life-like head sculpture mold is provided to create an accurate face configuration for the head portion of the mannequin, while a separate torso portion mold is provided to create a realistic torso portion having limbs both made by a latex dipping process. Eventually, the torso portion and the head portion are removed from respective molds and must be mechanically joined together to produce the finished life-like mannequin. However, mechanically joining the torso portion with the head portion produces a distinct joining line or seam along the connection site between the two joined portions that may detract from the life-like features of the mannequin.

Therefore, there is a need in the art for a mannequin having a unitary outer body that has a seamless transition between the torso portion and the head portion. Further, there is a need in the art for a process of manufacturing such a seamless mannequin having a unitary outer body that does not require the step of mechanically joining the torso portion to the head portion.

### BRIEF SUMMARY OF THE INVENTION

A primary object of the present invention is to provide a mannequin having life-like features.

Another object of the present invention is to provide a mannequin having a unitary outer body that has a seamless transition between the torso portion and the head portion of the mannequin.

Yet another object of the present invention is to provide a mannequin having an inflatable inner body disposed inside the outer body of the mannequin.

Another further object of the present invention is to provide a process of manufacturing a mannequin having a unitary body that does not require joining the torso portion with the head portion of the mannequin.

A further object of the present invention is to provide a process for manufacturing a mannequin that permits the inflatable inner body to be inserted into the outer body through an opening formed along the head portion during manufacture.

Yet another further object of the present invention is to provide a life-like mold having a torso member, head member, and tubular member adapted for producing a seamless mannequin in a latex dipping process.

In a preferred embodiment, the present invention comprises a seamless life-like mannequin comprising an inflatable outer body, the outer body including a torso portion and a head portion, and an inflatable inner body disposed inside the outer body, wherein the mannequin has a seamless transition between the torso portion and the head portion of the outer body.

In another embodiment, the present invention comprises a process for manufacturing a seamless mannequin comprising the steps of:
a) providing a mold comprising a torso member and a head member, the mold adapted to be used in a latex dipping process, the head member including a tubular member;
b) immersing the mold into a bath of liquid latex for a predetermined amount of time for producing a latex coating on the mold;
c) removing the mold having the latex coating from the bath of liquid latex, the latex coating having an inner surface and an outer surface;
d) removing the latex coating having a head portion, torso portion and tubular portion from the mold, the head portion, torso portion and tubular portion of the latex coating being defined by the head member, torso member and tubular member of the mold, the outer body defining a chamber, the tubular portion defining a hollow conduit in communication with the chamber through an opening defined along the head portion;
e) cutting off the tubular portion from the head portion; and
f) inserting an inner body inside the outer body through the opening.

In another embodiment, the present invention comprises a process for manufacturing a seamless life-like mannequin comprising:
a) providing a hollow inflatable outer body having a head portion and a torso portion, wherein the torso portion and the head portion have a seamless transition, the head portion defining an opening;
b) inserting an inflatable inner body through the opening of the outer body;
c) covering the opening of the head portion; and
d) inflating the inner body and the outer body.

Additional objects, advantages and novel features of the seamless life-like mannequin and process of manufacture thereof will be set forth in the description that follows, and will become apparent to those skilled in the art upon examination of the following more detailed description and drawings in which like elements of the invention are similarly numbered throughout.

These and other objects of the present invention are realized in the preferred embodiment of the present invention, described by way of example and not by way of limitation. Additional objects, advantages and novel features of the invention will be set forth in the description that follows, and will become apparent to those skilled in the art upon examination of the following more detailed description and drawings in which like elements of the invention are similarly numbered throughout.

### BRIEF DESCRIPTION OF THE SEVERAL VIEWS OF THE DRAWINGS

FIG. 1 is a front view of the seamless life-like mannequin according to the present invention;

FIG. 2 is a front view of the mold used to manufacture the seamless life-like mannequin according to the present invention;

FIG. 3 is a cross-sectional view of the seamless life-like mannequin taken along line 3-3 of FIG. 1 illustrating the inner body disposed inside the outer body of the mannequin according to the present invention;

FIG. 4 is a flow chart illustrating the process of manufacturing the seamless life-like mannequin according to the present invention;

FIG. 5 is a front view of the latex outer body of the seamless life-like mannequin with a tubular member extending from the head portion of the mannequin according to the present invention;

FIG. 6 is a front view of the latex outer body with the tubular member removed from the head portion defining an opening according to the present invention;

FIG. 7 is a front view of the latex outer body with the inner body being inserted through the opening of the head portion according to the present invention; and

FIGS. 8A-8L illustrate the sequences taken during the process for manufacturing the seamless life-like mannequin according to the present invention.

The foregoing summary, as well as the following detailed description of certain embodiments of the presently described technology, will be better understood when read in conjunction with the appended drawings. For the purpose of illustrating the presently described technology, certain embodiments are shown in the drawings. It should be understood, however, that the presently described technology is not limited to the arrangements and instrumentality shown in the attached drawings.

### DETAILED DESCRIPTION OF THE INVENTION

Referring to the drawings, the seamless life-like mannequin according to the present invention is illustrated and generally indicated as 10 in FIG. 1. As shown in FIG. 3, the seamless life-like mannequin 10 comprises an inflatable outer body 14 having a flexible inflatable inner body 16 disposed inside a chamber 32 defined by outer body 14. The outer body 14 comprises a head portion 18 and a torso portion 20 which are configured to provide seamless life-like mannequin 10 with life-like human features, such as eyes, mouth, nose and limbs that impart a human appearance.

Referring to FIG. 1, the outer body 14 is made of a unitary construction having a seamless transition between the torso portion 20 and the head portion 18. As used herein, the term “life-like” means that the seamless life-like mannequin 10 has a human appearance, while the term “seamless transition” means that there are no seams or joining lines between the torso portion 20 and head portion 18 of the mannequin 10. Preferably, the outer body 14 is made of a latex material that may be produced using a latex dipping process as shall be discussed below.

Referring back to FIG. 3, inflatable inner body 16 provides a flexible mannequin-shaped body adapted to be disposed inside and substantially conform to the shape of the outer body 14 during the manufacturing process. The inner body 16 further comprises a closable inlet (not shown) for providing a means to inflate the inner body 16 once disposed inside chamber 32 in order to provide structural support to the outer body 14.

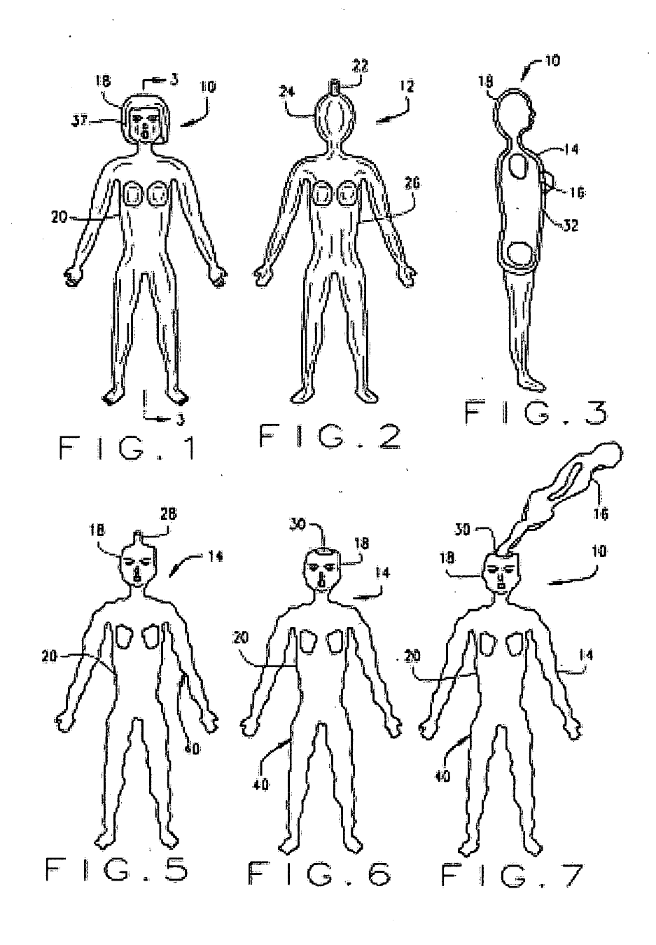

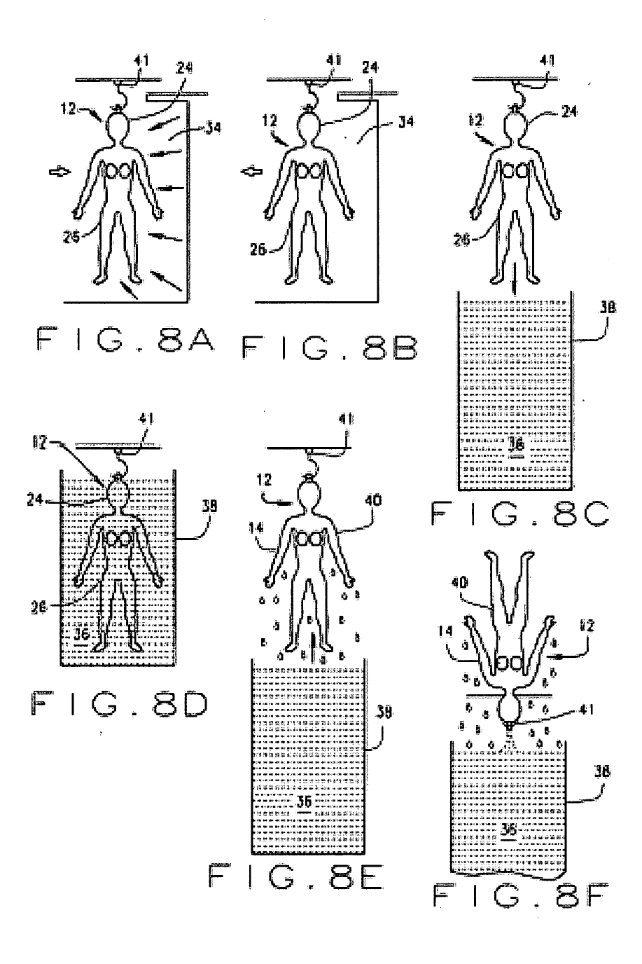

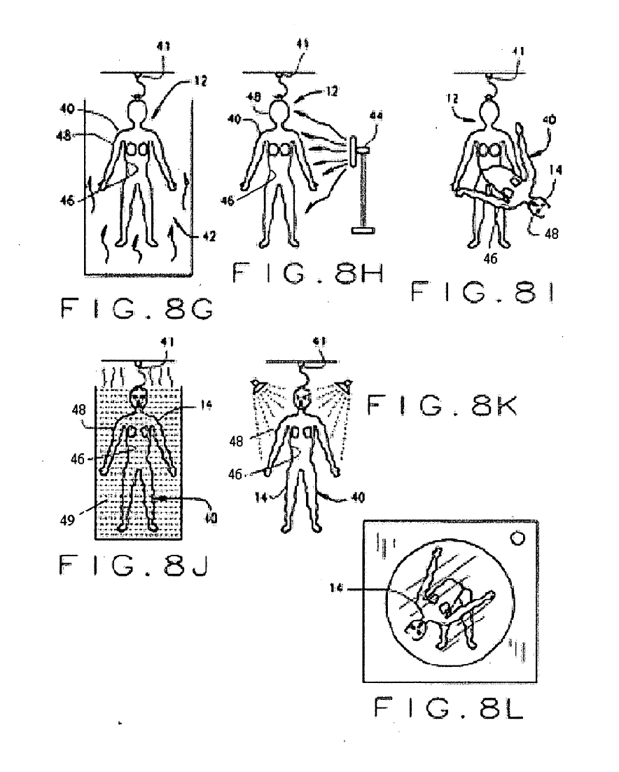

According to one aspect of the present invention, a process of manufacturing a mannequin 10 having a seamless transition between the head portion 18 and torso portion 20 shall be discussed. Referring to FIG. 2, a life-like mold 12 is provided for producing the latex coating 40 of the outer body 14 during the manufacture of mannequin 10. Preferably, the mold 12 is made of a die-cast metal and is hollow inside such that the weight of mold 12 just exceeds the buoyancy of liquid latex 36 used in the dipping process. As shown, the mold 12 comprises a head member 24 and torso member 26 with a tubular member 22 extending outwardly from head member 24. During the latex dipping process (FIG. 8D), the mold 12 is dipped in a bath of liquid latex 36 in order to produce the latex coating 40 used for the outer body 14 of mannequin 10.

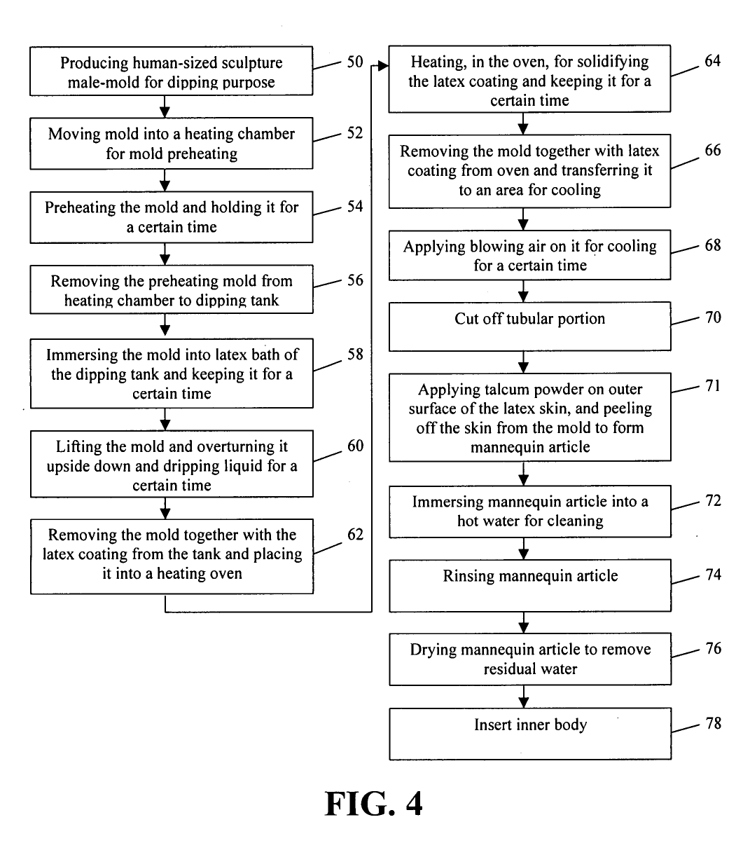

Referring to FIGS. 4 and 8A-8L, the process for manufacturing the mannequin 10 will be discussed in greater detail. At step 50, a life-like human sculpture for mold 12 is produced using techniques known in the art. Next, at step 52, the mold 12 is then moved into a heating chamber 34 for pre-heating the mold 12. The mold 12 is then pre-heated at step 54 (FIG. 8A). Preferably, the mold 12 is pre-heated by increasing the temperature to a predetermined threshold and maintaining that temperature for a predetermined amount of time. Preferably, the mold 12 is moved during the manufacturing process using a hook assembly 41 attached to the head member 24 of mold 12, although the present invention contemplates that assembly 41 may be attached to any portion of mold 12.

Next, at step 56 the pre-heated mold 12 is removed from the heating chamber 34 (FIG. 8B) and immersed into a dipping tank 38 containing liquid latex 36 for a predetermined amount of time at step 58 sufficient for producing a latex coating 40 having an inner surface 46 and outer surface 48 on mold 12 (FIGS. 8C-D). As illustrated in FIGS. 8E and 8F, the mold 12 is then removed from the dipping tank 38 at step 60 and turned upside down such that the latex coating 40 can drip off excess liquid latex 36 over a period of time. In an embodiment, mold 12 is removed from tank 38 at step 60 and repeatedly turned upwards and downwards such that excess liquid latex 36 can drip off of latex coating 40 and the remaining liquid latex can evenly spread over the surface of mold 12. This process of repeatedly turning mold 12 upwards and downwards can be performed over a predetermined period of time.

At step 62, the mold 12 and latex coating 40 is removed from the area of the dipping tank 38 and placed into a heating oven 42. At step 64, the latex coating 40 on mold 12 is heated in a heating oven 42 for a predetermined period of time such that the latex coating 40 is allowed to solidify (FIG. 8G). Once the latex coating 40 solidifies, the mold 12 is removed from the heating oven 42 at step 66 and transferred to an area suitable for cooling the latex coating 40 on mold 12 (FIG. 8H). In addition, a fan 44 may be utilized at step 68 to cool the latex coating 40 on mold 12, although other suitable means for cooling, such as forced air blowers or the like for generating air flow, are contemplated by one or more embodiments of the present invention.

After the latex coating 40 has sufficiently dried, at step 70 the hollow tubular portion 28 formed during the dipping process by the tubular member 22 of the mold 12 is cut such that an opening 30 is exposed along the top of head portion 18 of outer body 14. Next, talcum powder is preferably applied to the outer surface 48 at step 71 and the latex coating 40 is peeled off the mold 12 (FIG. 8I). Next at step 72, the outer body 14 is immersed in hot water 49 for washing and cleaning it at step 72 (FIG. 8J). The outer body 14 is then rinsed multiple times, and preferably at least three times at step 74 (FIG. 8K). As illustrated in FIG. 8L, the outer body 14 of mannequin is then dried at step 76.

Next at step 78, and referring to FIG. 7, when the inner body 16 is in a deflated condition, inner body 16 is inserted through opening 30 formed along head portion 18 by sufficiently stretching the opening 30 to allow insertion of the inner body 16 therein and orienting the various portions of the inner body 16 within the chamber 32 either manually or utilizing tools known in the art. Preferably, the inner body 16 is made from a sheet of polyvinyl chloride (PVC) to form an inflatable inner mannequin enclosure that substantially conforms to the approximate shape of the outer body 14 when inflated through the inlet by the user. Once the inner body 16 is disposed inside chamber 32 the inner body 16 and outer body 14 are inflated using respective inlets (not shown) that provide a means of inflating each respective body 14, 16. After inflation, a wig 37 may be placed on head portion 18 to cover opening 30 and to provide a realistic appearance to mannequin 10.

It should be understood from the foregoing that, while particular embodiments of the invention have been illustrated and described, various modifications can be made thereto without departing from the spirit and scope of the invention as will be apparent to those skilled in the art. Such changes and modifications are within the scope and teaching of this invention as defined in the claims appended hereto.

1. A method for manufacturing a mannequin comprising:
providing a mold comprising a torso member and a head member, said head portion including a tubular member;
immersing said mold into liquid latex for producing a latex coating on said mold, said latex coating having a head portion, torso portion and tubular portion;
removing said mold and said latex coating from said liquid latex;
removing said latex coating from said mold to create an outer mannequin body including a head portion, an internal chamber and a tubular portion connected to said head portion, said tubular portion defining a conduit between said internal chamber and an area outside said outer mannequin body;
cutting off said tubular portion to create an opening in said head portion; and
inserting an inner body inside said outer mannequin body through said opening.

2. The method of claim 1, wherein said step of providing said mold includes heating said mold before said immersing step.

3. The method of claim 1, further including heating said mold and said latex coating after said removing step.

4. The method of claim 1, wherein said step of removing said latex coating from said mold includes removing said latex coating so that a seamless transition between said head portion and said torso portion of said outer mannequin body exists.

5. The method of claim 1, further including applying a powder to said latex coating after said step of removing said latex coating from said mold.

6. The method of claim 1, further including immersing said latex coating in water after said step of removing said latex coating from said mold.

7. The method of claim 6, further including rinsing said latex coating after said step of immersing said latex coating in said water.

8. The method of claim 7, further including drying said latex coating after said rinsing step.

9. The method of claim 1, further including inflating at least one of said inner body and said outer mannequin body after said inserting step.

10. A method for manufacturing a mannequin comprising:
providing a hollow inflatable outer body having a head portion and a torso portion, wherein said torso portion and said head portion have a seamless transition, said head portion defining an opening;
inserting an inflatable inner body through said opening;
covering said opening of said head portion; and
inflating said inner body and said outer body.

11. The method of claim 10, wherein said providing step includes dipping a mold in liquid latex to form a latex coating on said mold.

12. The method of claim 10, wherein said providing step includes the steps of:
preheating said mold;
dipping said mold in liquid latex; and
solidifying said latex coating.

13. The method of claim 12, wherein said solidifying step includes heating said latex coating.

14. The method of claim 10, wherein said inserting and inflating steps cause said inner body to provide structural support to said outer body.

15. A method of manufacturing a mannequin, said method including:
providing a mold in a shape of a human being;
surrounding said mold with latex to create a latex coating;
removing said latex coating from said mold to create an outer mannequin body;
inserting an inner inflatable body into said outer mannequin body; and
inflating at least one of said inner inflatable body and said outer mannequin body.

16. The method of claim 15, wherein said inflating step includes inflating both of said inner inflatable body and said outer mannequin body.

17. The method of claim 15, wherein said step includes heating said mold prior to said surrounding step.

18. The method of claim 15, wherein said surrounding step includes immersing said mold in liquid latex.

19. The method of claim 15, further including exposing an opening in said outer mannequin body after said removing step,
wherein said inserting step includes said inner inflatable body into said outer mannequin body through said opening.

20. The method of claim 15, further including heating said latex coating after said surrounding step and before said removing step.
